(19) United States
(12) Patent Application Publication
(10) Pub. No.: US 2015/0207353 A1
(43) Pub. Date: Jul. 23, 2015

(54) ELECTRONIC DEVICE

(71) Applicant: Panasonic Intellectual Property Corporation of America, Torrance, CA (US)

(72) Inventors: Hiroyuki Oku, Kanagawa (JP); Masashi Nakagawa, Kanagawa (JP); Yoshiyuki Kashihara, Kanagawa (JP); Tadahiro Motoyama, Kanagawa (JP)

(21) Appl. No.: 14/601,092

(22) Filed: Jan. 20, 2015

(30) Foreign Application Priority Data
Jan. 23, 2014 (JP) 2014-010436

(51) Int. Cl. H02J 7/00

(52) U.S. Cl. CPC H02J 7/0052; H02J 2007/0096

(57) ABSTRACT

An electronic device is electrically connected to a secondary battery through a battery terminal, and is electrically connected to a charger through a charge connection section and a communication connection section. The electronic device includes a voltage range detection section, a switch section, a charge control section, and a device-side microcomputer. The charger includes a charger-side charge control section and a charger-side microcomputer. When certification data which is transmitted from the charger is prescribed data, the device-side microcomputer performs determination. When voltage range detection section determines that a charging voltage, which is applied to the charge connection section, is included in a prescribed range, the device-side microcomputer causes the switch section to be ON. The secondary battery is charged through the switch section or the charge control section or through both the sections.

### CROSS REFERENCE TO RELATED APPLICATIONS

This application claims priority to Japanese Patent Application No. 2014-010436 filed Jan. 23, 2014, the entire contents of which are incorporated by reference herein.

### BACKGROUND OF THE INVENTION

1. Field of the Invention

The present invention relates to an electronic device which is capable of safely charging a secondary battery.

2. Description of the Related Art

In recent years, an increase in battery capacity (large capacity), quick charging, and an increase in lifetime of a secondary battery have been required for an electronic device, which is a mobile terminal such as a smart phone or a tablet, in order to correspond to increased functions. Further, quick charging is necessary together with large capacity. However, high current flows through the electronic device when charge is performed.

In the related art, on the side of the electronic device, a charge control circuit (which, for example, drops a voltage from 5 V to 4 V or less) is provided that controls a (direct current) voltage from a charger (AC adaptor), which converts household AC into DC, into a voltage for a secondary battery. However, heat is generated due to conversion loss in the charge control circuit, and thus a problem occurs in that heat generation of the electronic device increases. Therefore, it has been proposed to mount the charge control circuit which mainly generates heat on the side of a stationary charger (AC adaptor) (for example, refer to Japanese Patent Unexamined Publication No. 2012-175895).

On the side of the electronic device disclosed in Japanese Patent Unexamined Publication No. 2012-175895, as a result of the charge control circuit being transferred to the side of the charger side, a circuit which substantially controls a voltage and a current does not exist between the terminals of the electronic device, which are connected to the secondary battery and the charger. Therefore, even when the terminal of the secondary battery is not physically exposed, a terminal having approximately the same potential as the secondary battery may be exposed to the outside. In addition, even when such a circuit exists, the terminal having approximately the same potential as the secondary battery may be exposed to the outside depending on a control state. In such a state, there is a possibility that short circuit due to contact with a foreign substance, damage of the electronic device due to connection with a faulty charger, or the like may occur. Therefore, it is difficult to say that a user is under a situation in which the user can use the electronic device without anxiety.

### SUMMARY OF THE INVENTION

According to the present invention, there is provided an electronic device including: first and second charge connection sections that can be connected to at least one external charger; a battery terminal that can be connected to a secondary battery when the detachable secondary battery is attached; a switch section that can switch conduction and cut-off of an electrical path which electrically connects between the first charge connection section and the battery terminal; a communication connection section that can at least receive first certification data and transmit second certification data to and from the at least one external charger; and a charge control section that can output at least a part of charging power, which is supplied from the second charge connection section, to the secondary battery. The switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and the secondary battery can be charged using the charging power which is supplied to any one of the first and second charge connection sections.

According to the present invention, there is provided an electronic device including: first and second charge connection sections that can be connected to at least one external charger; a battery terminal that can be connected to a secondary battery when the detachable secondary battery is attached; a switch section that can switch conduction and cut-off of an electrical path which electrically connects between the first charge connection section and the battery terminal; a communication connection section that can at least receive first certification data and transmit second certification data to and from the at least one external charger; and a charge control section that can output at least a part of charging power, which is supplied from the second charge connection section, to the secondary battery. The switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and the secondary battery can be charged using the charging power which is supplied from the first and second charge connection sections at the same time.

In the electronic device according to the present invention, for example, the charging power which is supplied from the first charge connection section may be greater than the charging power which is supplied from the second charge connection section.

In the electronic device according to the present invention, at least command data or message data may be transmitted and received through the communication connection section, and the charging power may be supplied to at least one of the first and second charge connection sections based on the transmitted command data or message data.

According to the present invention, there is provided an electronic device including: a charge connection section that can be connected to at least one external charger; a battery terminal that can be connected to a secondary battery when the detachable secondary battery is attached; a first switch section that enables an electrical path which is connected to the charge connection section to be branched; a second switch section that can switch conduction and cut-off of the electrical path which electrically connects between the first switch section and the battery terminal; a communication connection section that can at least receive first certification data and transmit second certification data to and from the at least one external charger; and a charge control section that can output at least a part of charging power, which is supplied from the charge connection section through the first switch section, to the secondary battery. The second switch section can be electrically conducted when the first certification data, which is received by the electronic device, is prescribed data and when a charging voltage, which is applied to the charge connection section after the electronic device transmits the second certification data, is included in a prescribed range, and cannot be electrically conducted at least when the received first certification data is not the prescribed data, and the secondary battery can be charged through any one of the charge control section and the second switch section.

In the electronic device according to the present invention, for example, at least command data or message data may be transmitted and received through the communication connection section, and the charging power may be supplied to the secondary battery through any one of the charge control section and the second switch section in response to the transmitted command data or message data.

According to the present invention, there is provided an electronic device including: a charge connection section that can be connected to at least one external charger; a battery terminal that can be connected to a secondary battery when the detachable secondary battery is attached; a switch section that can switch conduction and cut-off of a first electrical path which electrically connects between the charge connection section and the battery terminal; a communication connection section that can at least receive first certification data and transmit second certification data to and from the at least one external charger; and a charge control section that can output at least a part of charging power, which is supplied from the charge connection section through a second electrical path which electrically connects between the charge connection section and the battery terminal, to the secondary battery. The switch section can be electrically conducted when the first certification data, which is received by the electronic device, is prescribed data and when a charging voltage, which is applied to the charge connection section after the electronic device transmits the second certification data, is included in a prescribed range, and cannot be electrically conducted at least when the received first certification data is not the prescribed data, and the secondary battery can be charged through at least one of the charge control section and the switch section.

In the electronic device according to the present invention, for example, at least command data or message data may be transmitted and received through the communication connection section, and the charging power may be supplied to the secondary battery through any one of the charge control section and the switch section in response to the transmitted command data or message data.

According to the present invention, there is provided an electronic device including: first and second charge connection sections that can be connected to at least one external charger; a battery terminal that can be connected to a secondary battery when the detachable secondary battery is attached; a first charge control section that can output at least a part of charging power, which is supplied from the first charge connection section, to the secondary battery; a switch section that can switch conduction and cut-off of an electrical path which electrically connects between the first charge control section and the battery terminal; a communication connection section that can at least receive first certification data and transmit second certification data to and from the at least one external charger; and a second charge control section that can output at least a part of charging power, which is supplied from the second charge connection section, to the secondary battery. The switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and the secondary battery can be charged using the charging power which is supplied to any one of the first and second charge connection sections.

According to the present invention, there is provided an electronic device including: first and second charge connection sections that can be connected to at least one external charger; a battery terminal that can be connected to a secondary battery when the detachable secondary battery is attached; a first charge control section that can output at least a part of charging power which is supplied from the first charge connection section to the secondary battery; a switch section that can switch conduction and cut-off of an electrical path which electrically connects between the first charge control section and the battery terminal; a communication connection section that can at least receive first certification data and transmit second certification data to and from the at least one external charger; and a second charge control section that can output at least a part of charging power which is supplied from the second charge connection section to the secondary battery. The switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and the secondary battery can be charged using the charging power which is supplied from the first and second charge connection sections at the same time.

In the electronic device according to the present invention, the charging power which is supplied from the first charge connection section may be greater than the charging power which is supplied from the second charge connection section.

In the electronic device according to the present invention, at least command data or message data may be transmitted and received through the communication connection section, and the charging power may be supplied to at least one of the first and second charge connection sections based on the transmitted command data or message data.

According to the present invention, there is provided an electronic device including: a charge connection section that can be connected to at least one external charger; a battery terminal that can be connected to a secondary battery when the detachable secondary battery is attached; a first charge control section that can output at least a part of charging power supplied from the charge connection section to the secondary battery; a switch section that can switch conduction and cut-off of a first electrical path which electrically connects between the charge connection section and the battery terminal; a communication connection section that can at least receive first certification data and transmit second certification data to and from the at least one external charger; and a second charge control section that can output at least a part of charging power, which is supplied from the charge connection section through a second electrical path which electrically connects between the charge connection section and the battery terminal, to the secondary battery. The switch section can be electrically conducted when the first certification data, which is received by the electronic device, is prescribed data and when a charging voltage, which is applied to the charge connection section after the electronic device transmits the second certification data, is included in a prescribed range, and cannot be electrically conducted at least when the received first certification data is not the prescribed data, and the secondary battery can be charged through any one of the second charge control section and the switch section.

In the electronic device according to the present invention, at least command data or message data may be transmitted and received through the communication connection section, and the charging power may be supplied to the secondary battery through any one of the second charge control section and the switch section in response to the transmitted command data or message data.

In the electronic device according to the present invention, the charging power which is output from the first charge control section may be greater than the charging power which is output from the second charge control section. According to the electronic device of the present invention, it is possible to determine whether or not the external charger and the secondary battery, which are electrically connected to the electronic device, are normal (for example, genuine) connection devices which are recognized by the electronic device, and it is possible to determine whether or not an applying voltage is appropriate to charge the secondary battery. Based on the determinations, the secondary battery is safely charged by the normal charger, the lifetime of the secondary battery is improved, and thus the electronic device can be electrically protected. In addition, a route for secondary battery charge supply is selected on the side of the electronic device, and thus it is possible to perform appropriate charge in accordance with the voltage of the secondary battery.

### BRIEF DESCRIPTION OF DRAWINGS

FIG. 1 is a block diagram illustrating an example of an electronic device according to a first exemplary embodiment of the present invention;

FIG. 2 is a flowchart illustrating an example of certification according to the first exemplary embodiment;

FIG. 3 is a flowchart illustrating an example of certification of a charger according to the first exemplary embodiment;

FIG. 4 is an explanation table illustrating an example of a step of determining whether or not the electronic device according to the first exemplary embodiment is in a chargeable state;

FIG. 5 is a flowchart illustrating an example of charging according to the first exemplary embodiment;

FIG. 6 is a conceptual diagram illustrating an example of the charging according to the first exemplary embodiment using a graph and table;

FIG. 7 is a table for comparing the present invention (first exemplary embodiment) with the related art;

FIG. 8 is a block diagram illustrating an example of an electronic device according to a second exemplary embodiment of the present invention;

FIG. 9 is a block diagram illustrating an example of an electronic device according to a third exemplary embodiment of the present invention;

FIG. 10 is a block diagram illustrating an example of an electronic device according to a fourth exemplary embodiment of the present invention;

FIG. 11 is a block diagram illustrating an example of an electronic device according to a fifth exemplary embodiment of the present invention;

FIG. 12 is a block diagram illustrating an example of an electronic device according to a sixth exemplary embodiment of the present invention;

FIG. 13 is a block diagram illustrating an example of an electronic device according to a seventh exemplary embodiment of the present invention;

FIG. 14 is a block diagram illustrating an example of an electronic device according to an eighth exemplary embodiment of the present invention;

FIG. 15 is a block diagram illustrating an example of an electronic device according to a ninth exemplary embodiment of the present invention;

FIG. 16 is a block diagram illustrating an example of an electronic device according to a tenth exemplary embodiment of the present invention; and

FIG. 17 is a block diagram illustrating an example of an electronic device according to an eleventh exemplary embodiment of the present invention.

### DETAILED DESCRIPTION OF PREFERRED EMBODIMENTS

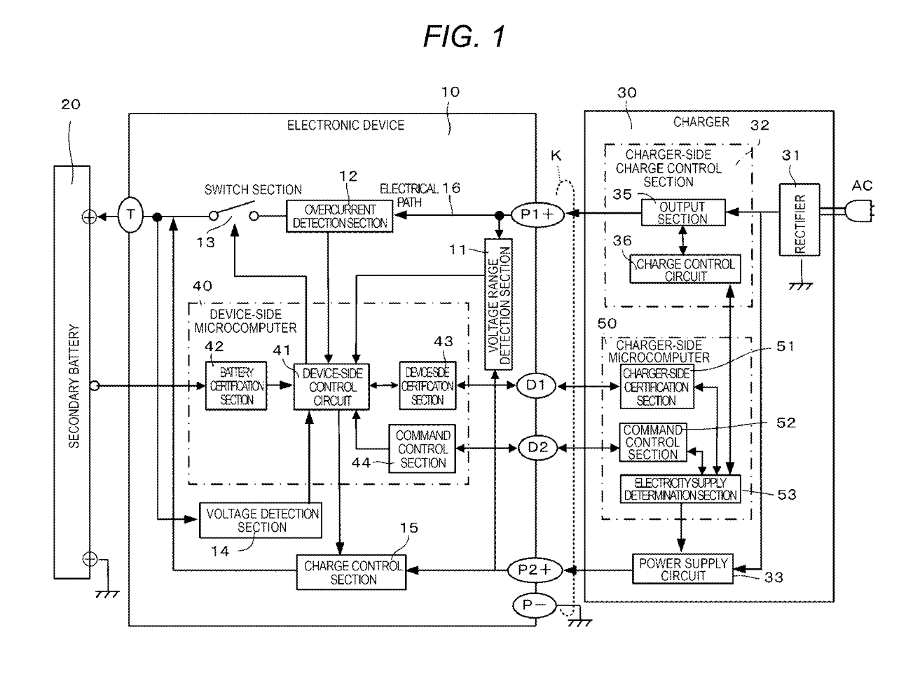

Hereinafter, an electronic device according to preferable embodiments of the present invention will be described with reference to FIGS. 1 to 17.

### First Exemplary Embodiment

FIG. 1 is a block diagram illustrating an example of an electronic device according to the first exemplary embodiment of the present invention.

Electronic device 10 is electrically connected to external secondary battery 20 and external charger 30 which charges secondary battery 20. In addition, electronic device 10 may include secondary battery 20.

Electronic device 10 may be, for example, a mobile phone such as a smart phone, a mobile terminal such as a tablet, or a mobile device, such as a digital camera, a portable personal computer, or a wireless device, which is operated by a secondary battery 20. Electronic device 10 includes voltage range detection section 11, overcurrent detection section 12, switch section 13, voltage detection section 14, charge control section 15, and device-side microcomputer 40. In addition, electronic device 10 includes a battery terminal T which can be electrically connected to secondary battery 20, charge connection section P which can be electrically connected to external charger 30, communication connection section D which transmits and receives certification, commands, or the like, and electrical path 16 which causes each component to be conductible.

Further, in the first exemplary embodiment, plural charge connection sections P and plural communication connection sections D are provided. Charge connection section P includes at least first charge connection section P1 and second charge connection section P2, and communication connection section D includes at least first communication connection section D1 and second communication connection section D2. In addition, device-side microcomputer 40 includes device-side control circuit 41, battery certification section 42, device-side certification section 43, and command control section 44 on the side of electronic device 10.

Voltage range detection section 11 detects the voltage of charge connection section P which is electrically connected to charger 30, and transmits a measured voltage value to, for example, device-side control circuit 41 of device-side microcomputer 40. In the first exemplary embodiment, voltage range detection section 11 detects the voltage of second charge connection section P2 to which power is simultaneously or alternately supplied with first charge connection section P1. Basically, charging power supplied from first charge connection section P1 is greater than charging power supplied from second charge connection section P2. That is, although a part of the charging power, which is supplied to secondary battery 20, is supplied by first charge connection section P1 and second charge connection section P2, it is preferable that charging power supplied from first charge connection section P1 be equal to or greater than half the entire charging power to be supplied.

Overcurrent detection section 12 transmits a current value, acquired by detecting and measuring a current value which flows through first charge connection section P1, to, for example, device-side control circuit 41 of device-side microcomputer 40.

Switch section 13 is electrically connected to first charge connection section P1 and secondary battery 20 through electrical path 16, is caused to be ON or OFF based on an instruction of device-side microcomputer 40, and can switch conduction and cut off between first charge connection section P1 and secondary battery 20. That is, device-side microcomputer 40 determines certification data or value data which are transmitted from each of the components, and causes switch section 13 to be ON when it is determined that each of the data is safe even if secondary battery 20 is charged. Therefore, first charge connection section P1, which is connected to charger 30, and secondary battery 20 are in a conductive state. In addition, when device-side microcomputer 40 determines false certification or determines an overvoltage or overcurrent state, device-side microcomputer 40 causes switch section 13 to be OFF in order to stop or forbid a charging operation, and cuts off the electrical connection between first charge connection section P1 and secondary battery 20.

Voltage detection section 14 is, for example, a battery monitoring circuit because voltage detection section 14 acquires battery information, such as the voltage of secondary battery 20, and transmits the acquired battery information to, for example, device-side control circuit 41 of device-side microcomputer 40.

Charge control section 15 receives an instruction of device-side microcomputer 40 and controls auxiliary charge or constant voltage charge of secondary battery 20, which will be described later. Device-side microcomputer 40 determines the certification data and the value data which are transmitted from each of the components. When it is determined that each of the data is safe even if secondary battery 20 is charged, device-side microcomputer 40 causes at least the output of charge control section 15 to be ON. Therefore, second charge connection section P2, which is connected to charger 30, and secondary battery 20 are in a conductive state. In addition, when device-side microcomputer 40 determines false certification or determines an overvoltage or overcurrent state, device-side microcomputer 40 causes at least the output of charge control section 15 to be OFF in order to stop or forbid a charging operation, and cuts off the electrical connection between second charge connection section P2 and secondary battery 20.

Device-side control circuit 41 of device-side microcomputer 40 is a protection control circuit that includes, for example, a microprocessor which processes, controls, and determines signals from the above-described components included in electronic device 10, and transmits instruction signals, and that can safely perform rapid charging on secondary battery 20.

Device-side control circuit 41 (hereinafter, description will be made after the electronic device side is abbreviated to a device side) determines whether or not the voltage value of the charging power, which is transmitted from voltage range detection section 11, is included in a prescribed range (for example, 5 V), and, at the same time, determines whether or not an overvoltage state occurs. In addition, device-side control circuit 41 determines whether or not the current value, which is transmitted from overcurrent detection section 12, is included in a prescribed range (for example, 4 A), and, at the same time, determines whether or not an overcurrent state occurs. Meanwhile, if the state is not the overcurrent state, it is possible to flow a current which is higher than a prescribed current. Although the determinations, which are performed by device-side control circuit 41, have been described, determination may be performed by voltage range detection section 11 and overcurrent detection section 12, and a notification may be provided to device-side control circuit 41 when the voltage value and the current value are not in the prescribed range which includes the overvoltage or overcurrent.

Further, device-side control circuit 41 acquires the battery information transmitted from voltage detection section 14, determines whether or not the battery information is necessary information for operating charge control section 15, and transmits the battery information to charger-side microcomputer 50 through, for example, an I2C serial bus in the form of a digital signal which is less deteriorated or erroneously transmitted. The signal includes an instruction (command) or the like for rapid charging or the like performed on the side of charger 30, in addition to determination information.

Battery certification section 42 acquires the certification data from secondary battery 20 which is electrically connected to electronic device 10, and determines whether or not secondary battery 20 is suitable as a battery which is used in electronic device 10. It is possible to acquire information, such as the battery voltage or the temperature of secondary battery 20, in addition to the certification data.

Device-side certification section 43 acquires the certification data from external charger 30 which is electrically connected to electronic device 10 through first communication connection section D1, and determines whether or not charger 30 is suitable as a connection device which is used in electronic device 10. Command control section 44 acquires command data, message data, or the like, which includes the certification data or the prescribed data from charger 30, through second communication connection section D2, and transmits the command data, the message data, or the like to device-side control circuit 41.

The above-described certification data may be, for example, data which is transmitted at prescribed intervals and which enables determination of whether or not secondary battery 20 or charger 30 is a normal connection device for electronic device 10, and may be advanced encoded data, such as a random number which is formed using a prescribed algorithm. Hereinafter, for easy understanding of description, certification data indicative of a normal connection device is referred to as prescribed data. In addition, data which is transmitted from charger 30 to electronic device 10 is referred to as a first certification data, data which is transmitted from electronic device 10 to charger 30 is referred to as a second certification data, and data which is transmitted from secondary battery 20 to electronic device 10 is referred to as a third certification data.

The above-described configuration of electronic device 10 is described centering on a function relative to charging performed on secondary battery 20 and other components, such as a display section and an input section, are omitted. However, electronic device 10 is not limited to the above-described configuration.

Secondary battery 20 is, for example, a secondary battery, such as a lithium-ion secondary battery or a nickel-hydrogen secondary battery, which is charged with power supplied from external charger 30 or the like, and operates various components included in electronic device 10 using the charged power. In addition, electrical connection between electronic device 10 and secondary battery 20 is performed by the battery terminal T which is provided on the side of electronic device 10. For example, from the top of the drawing, a positive electrode terminal (+terminal), a certification terminal, and a negative electrode terminal (−terminal) are provided.

Charger 30, which is electrically connected to electronic device 10 and is detachable, is an AC adaptor type that includes a plug which can be electrically connected to an external commercial AC power source, and includes rectifier 31, charger-side charge control section 32, charger-side microcomputer 50, and power supply circuit 33. In addition, charger-side charge control section 32 includes output section 35 and charge control circuit 36, and charger-side microcomputer 50 includes charger-side certification section 51, command control section 52, and power supply determination section 53. Further, charger 30 is electrically connected to electronic device 10 through code K, in which plural conducting wires are bundled, for example, through a pin-shaped connector or a USB connector which is provided on the tip of code K.

Rectifier 31 is a power conversion device which converts (rectifies) alternating current power (AC) into direct current power (DC), and supplies power to charger-side charge control section 32 and power supply circuit 33. Output section 35 of charger-side charge control section 32 outputs power, which is supplied to secondary battery 20 based on the instruction of charge control circuit 36, to first charge connection section P1. In addition, in the first exemplary embodiment, charge control circuit 36 transmits the instruction to power supply circuit 33 through power supply determination section 53, and outputs power to be supplied to secondary battery 20 to second charge connection section P2.

Charge control circuit 36 of charger-side charge control section 32 includes a microprocessor which controls output section 35 of charger 30 and determines the signal from power supply determination section 53, supplies power which is capable of causing secondary battery 20 to be charged, and supplies suitable power while grasping a charge state. Charge control circuit 36 controls various rapid charging methods, for example, a −ΔV control charging method, a dT/dT control charging method, a step control charging method, and the like, and the rapid charging method can be selected in accordance with performance of secondary battery 20, the purpose of use of electronic device 10, and the like. Charger-side certification section 51 of charger-side microcomputer 50 receives the second certification data from first communication connection section D1 that can receive the second certification data which is the certification data transmitted from electronic device 10, and determines whether or not the second certification data is the prescribed data indicative of normal electronic device 10 which is recognized by charger 30. The second certification data may be data which is transmitted, for example, at prescribed intervals and which enables determination of whether or not electronic device 10 is a normal connection device for charger 30. In addition, the second certification data may be advanced encoded data, such as a random number which is formed using a prescribed algorithm. Further, when the first certification data and the second certification data are mutually certified, electronic device 10 and charger 30 can perform cross certification.

Command control section 52 on the side of charger 30 transmits the command data or the like to power supply determination section 53, and transmits the command data or the message data, which includes the certification data, the prescribed data or the like, to electronic device 10 through second communication connection section D2. Power supply determination section 53 receives digital signal from command control section 52, and instructs determination and operation of ON/OFF of power supply circuit 33 and charge control circuit 36.

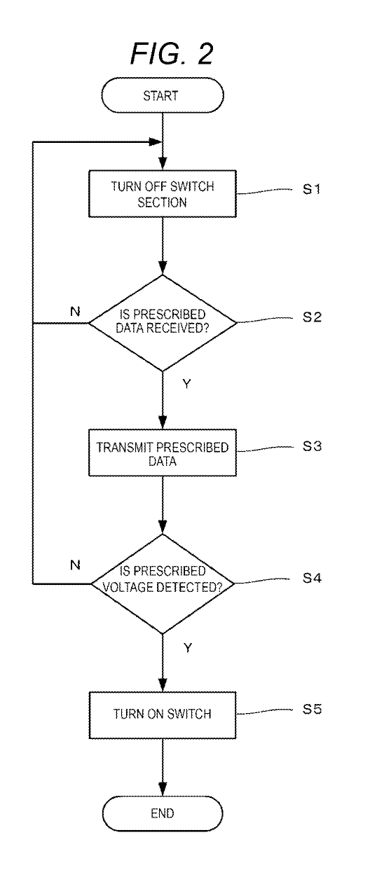

FIG. 2 is a flowchart illustrating an example of certification of electronic device 10.

Switch section 13 of electronic device 10 is initially in an OFF state (step S1). When charger 30 is connected to electronic device 10, device-side certification section 43 determines whether or not the first certification data, which is acquired from charger 30 through first communication connection section D1, is the prescribed data in which it is possible to determine that charger 30 is a suitable external connection device (for example, genuine) (step S2). When device-side certification section 43 determines that the first certification data is the prescribed data (Y in step S2), device-side certification section 43 transmits the second certification data to charger 30 through first communication connection section D1 (step S3).

Subsequently, device-side control circuit 41 determines whether or not the voltage (applied charging voltage), which is supplied to first charge connection section P1 of electronic device 10 from charger 30, is detected in a range of a prescribed voltage which is suitable to perform charging on secondary battery 20 (step S4). When device-side control circuit 41 determines that the voltage is included in the range of the prescribed voltage (Y in step S4), device-side control circuit 41 causes switch section 13 to be ON (step S5). When device-side certification section 43 determines that the first certification data is not the prescribed data (N in step S2) and when device-side control circuit 41 determines that the first certification data is not included in the range of the prescribed voltage (N in step S4), device-side control circuit 41 maintains switch section 13 in the OFF state.

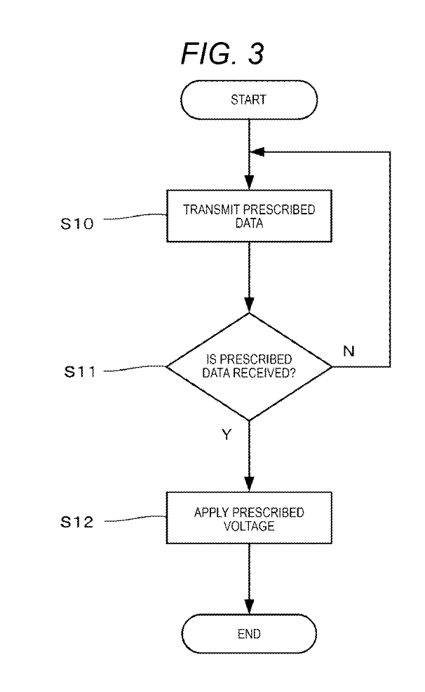

FIG. 3 is a flowchart illustrating an example of the certification of charger 30.

When charger 30 is connected to electronic device 10, the first certification data (prescribed data) for certification is transmitted to electronic device 10 from charger-side certification section 51. The first certification data is used to determine whether or not the prescribed data in step S2 of FIG. 2 is received. Subsequently, charger-side certification section 51 of charger 30 determines whether or not the second certification data, which is acquired from electronic device 10 through first communication connection section D1, is the prescribed data in which it is possible to determine whether or not electronic device 10 is a suitable external connection device (step S11). The second certification data is data which is transmitted in step S3 of FIG. 2.

When charger-side certification section 51 determines that the second certification data is the prescribed data (Y in step S11), a prescribed voltage, which is suitable for charging, is applied to electronic device 10. That is, charger-side certification section 51 provides a notification that certification is completed to charge control circuit 36, charge control circuit 36 instructs output section 35 to supply the prescribed voltage, which is suitable for charging, and output section 35 applies the prescribed charging voltage to first charge connection section P1 (step S12). In the first exemplary embodiment, the prescribed voltage is applied to second charge connection section P2 from power supply circuit 33 according to charging phase. When charger-side certification section 51 does not receive the prescribed data (N in step S11), the process returns to step S10.

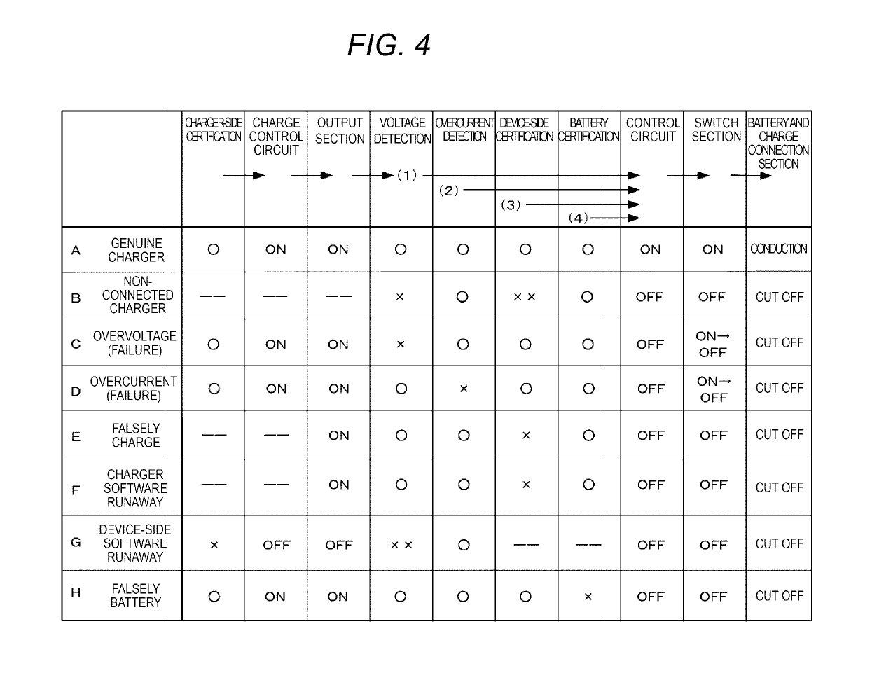

FIG. 4 is an explanation table illustrating an example of a step of determining whether or not the electronic device according to the first exemplary embodiment is in a chargeable state. A detailed protection operation will be described later based on an explanation table. The explanation table lists a detailed situation (case) on each row, and lists items to be certified, detected, and controlled on respective columns.

Case A (normal (for example, genuine) charger): a case in which genuine charger 30 is connected to electronic device 10. When genuine charger 30 is connected to electronic device 10, charger-side certification section 51 determines whether or not electronic device 10 is normal electronic device 10 based on the second certification data. When the second certification data is certified as the prescribed data, charge control circuit 36 transmits a voltage value and a current value which are necessary for charging to output section 35, and output section 35 outputs power to first charge connection section P1. Power supply determination section 53 transmits an instruction to power supply circuit 33, and power supply circuit 33 outputs power to second charge connection section P2.

Meanwhile, in the first exemplary embodiment, power is output to one of or both first charge connection section P1 and second charge connection section P2 based on charge phase which will be described later.

Voltage range detection section 11 detects the charging voltage from first charge connection section P1 and second charge connection section P2 and notifies the charging voltage to device-side control circuit 41. Device-side control circuit 41 determines that the charging voltage in the prescribed range is applied (refer to Table 1). Overcurrent detection section 12 detects the current value which flows through charge connection section P1, and notifies the current value to device-side control circuit 41. Device-side control circuit 41 determines that the current value is in the prescribed range (refer to Table 2).

When the first certification data, which is transmitted from charger 30, is the prescribed data, device-side certification section 43 certifies that charger 30 is genuine, and provides a notification that charger 30 is genuine to device-side control circuit 41 (refer to Table 3). When the third certification data, which is transmitted from secondary battery 20, is the prescribed data, battery certification section 42 certifies that secondary battery 20 is a normal (for example, genuine) connection device, and provides a notification that secondary battery 20 is a normal connection device, to device-side control circuit 41 (refer to Table 4). When all signals 1 to 4 are OK, a notification that it is possible to perform charging is provided from command control section 44 to command control section 52 on the charger side, with the result that power supply determination section 53 causes charge control circuit 36 to be ON, and thus prescribed power is output by output section 35. At the same time, device-side control circuit 41 causes at least one or both of the outputs of switch section 13 and charge control section 15 to be ON, with the result that secondary battery 20 and first charge connection section P1 are in the conductive state, and thus secondary battery 20 starts to be charged.

At the same time, power supply circuit 33 is caused to be ON, with the result that second charge connection section P2 is in the conductive state, and thus secondary battery 20 starts to be charged. There is a case in which only one of first charge connection section P1 and second charge connection section P2 conducts power or a case in which the first charge connection section P1 and second charge connection section P2 conduct power at the same time.

Case B (non-connected charger): a case in which charger 30 is not connected to electronic device 10. In the case in which charger 30 is not connected, it is difficult to perform voltage detection in voltage range detection section 11 and certification in the device-side certification section 43, with the result that switch section 13 is in an OFF state and secondary battery 20 and first charge connection section P1 are in a cut-off state, and thus charging is not performed. At the same time, device-side control circuit 41 causes at least the output of charge control section 15 to be in an OFF state. In the table, voltage detection is “x” and device-side certification is also “xx” according to the casual relation. However, there is problem in that short circuit occurs because first charge connection section P1 or second charge connection section P2, which is in an uncovered (exposed) state, is stained or a foreign substance comes into contact therewith. Even in such a case, at least the outputs of switch section 13 and charge control section 15 are in the OFF state, and thus electronic device 10 and secondary battery 20 are electrically protected.

Case C (overvoltage) and case D (overcurrent): a case in which an overvoltage or an overcurrent is detected. When device-side control circuit 41 determines that an abnormality occurs because a voltage value detected in voltage range detection section 11 or a current value detected in overcurrent detection section 12 exceeds the prescribed range, switch section 13 is caused to be OFF directly, and thus secondary battery 20 and first charge connection section P1 are in the cut-off state. At the same time, at least the output of charge control section 15 is in an off state, and thus charging from charge control section 15 is not performed. The voltage detection is “x” in case C and the overcurrent detection is “x” in case D, and thus switch section 13 switches from “ON to OFF”.

Case E (false charge): charging performed by a non-normal article which is not normal (for example, genuine) charger 30. In this case, the first certification data which is received in device-side certification section 43 is not the prescribed data (refer to device-side certification “x”), with the result that device-side control circuit 41 does not cause switch section 13 to be ON, and thus secondary battery 20 and charge connection section P1 are in a cut-off state and charging is not performed. At the same time, at least the output of charge control section 15 is in an OFF state, and thus charging from charge control section 15 is not performed.

Case F (charger software runaway) and case G (device-side software runaway): a case in which software abnormality, for example, software runaway occurs. In device-side control circuit 41 and charge control circuit 36, software is incorporated in order to safely perform charging. There is a case in which software abnormality occurs. In this case, certification is not performed by device-side certification section 43 and charger-side certification section 51 (refer to device certification and charger-side certification “x”), device-side control circuit 41 does not cause switch section 13 to be ON, secondary battery 20 and charge connection section P1 are in a cut-off state, and thus charging is not performed. At the same time, at least output of charge control section 15 is also in an OFF state, and charging from charge control section 15 is not performed. In addition, in case G, power is not supplied from output section 35, thereby causing a state in which it is difficult to detect a voltage in voltage range detection section 11 (refer to voltage detection “xx”).

Case H (faulty battery): a case in which an inappropriate (non-normal article) secondary battery 20 is connected to electronic device 10 as secondary battery 20. In battery certification section 42, when it is determined that the third certification data is not the prescribed data or the third certification data is not transmitted (refer to battery certification “x”), device-side control circuit 41 does not cause at least the output of switch section 13 and charge control section 15 to be ON. In addition, power supply determination section 53 does not cause power supply circuit and charge control circuit 36 to be ON. Further, secondary battery 20, first charge connection section P1, and second charge connection section P2 are in the cut-off state, and thus charging is not performed.

Although the operation of each of the components of electronic device 10 and charger 30 in order to safely charge secondary battery 20 has been described with reference to FIG. 4, the present invention is not particularly limited to the described content. It is necessary to monitor the heat generation of charge control circuit 36, the charge state of secondary battery 20, and the like during quick charging, and it is possible to appropriately use various protection circuits and protection programs in order to perform charge without anxiety.

As disclosed in PTL 1, it is generally known that a circuit which controls a voltage and a current is not provided on the side of electronic device 10 and a charge circuit is mounted on the side of charger 30. However, the distance between the charge control circuit 36 and the secondary battery 20 becomes longer, and it is difficult to exactly grasp and control the voltage of secondary battery 20 because of the resistance of code K. In addition, if charge is performed in a state in which it is difficult to exactly grasp the voltage of secondary battery 20, it is difficult to use an appropriate charge state according to the voltage state of the secondary battery 20, and there is a possibility that problems, such as acceleration of deterioration of the performance of secondary battery 20 due to excessive voltage application, occurs. In the present invention, a function related to charge control is included on the side of electronic device 10, appropriate charge is performed according to the voltage of secondary battery 20, and heat in accordance with charge from electronic device 10 is restricted to the minimum, thereby aiming to secure both quick charging and safety.

More specifically, charge control circuit 36 or the like is mounted on the side of charger 30 in order to avoid generation of heat of electronic device 10 when charge is performed. However, code K is necessary to electrically connect electronic device 10 to charger 30, and the resistance of code K exists. For example, when it is assumed that a resistance of 1.0Ω exists in code K, a loss of 4.0 V occurs at 4.0 A, with the result being that a charging voltage of 4.34 V, which should not be exceeded, is seen as 8 V, and thus there is a possibility that it is difficult to safely control charge. In the present invention, since voltage detection section 14 which monitors the voltage of secondary battery 20 and charge control section 15 which can be charged with a small amount of current are provided on the side of electronic device 10, it is possible to perform appropriate charge in accordance with the voltage of secondary battery 20.

Subsequently, the operation and control of each of the components for each phase (auxiliary charge, constant current charge, or constant voltage charge) will be described in detail.

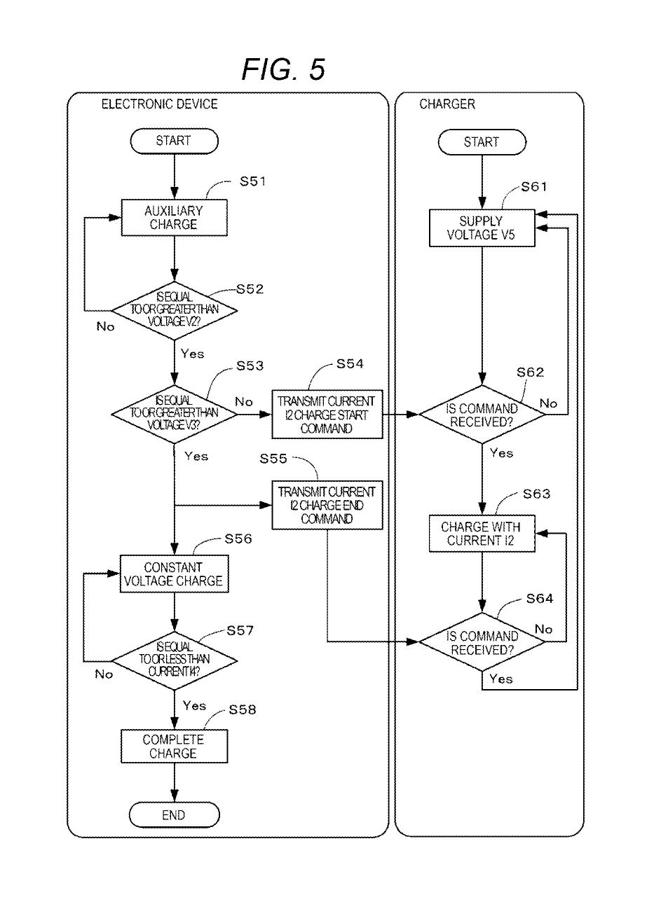

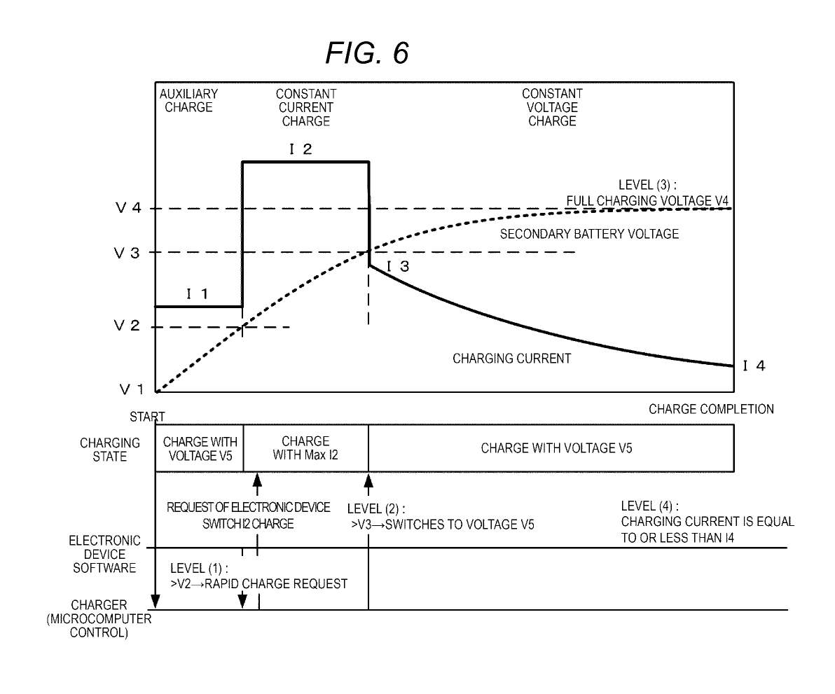

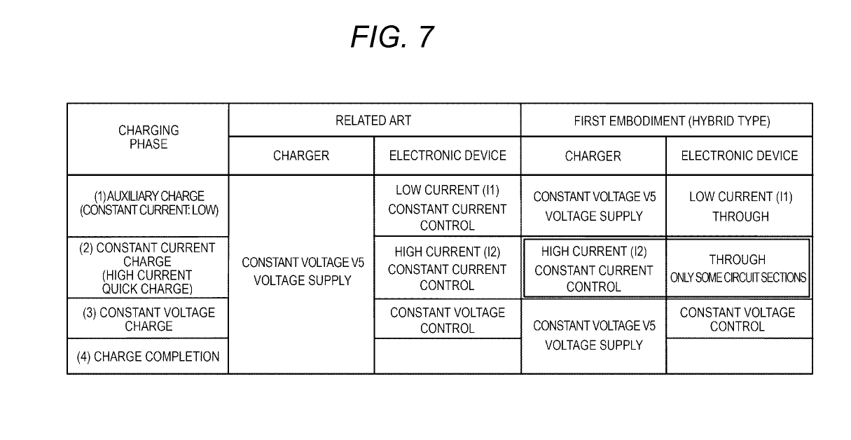

FIG. 5 is a flowchart illustrating an example of charge according to the first exemplary embodiment, and FIG. 6 is a conceptual diagram illustrating the example of charge using a graph and a table. An example of an operation according to the first exemplary embodiment will be further described with reference to FIGS. 6 and 7.

A flowchart on the left side of FIG. 5 illustrates the flow of an operation of electronic device 10 and a flowchart on the right side illustrates the flow of an operation of charger 30. Quick charging includes three phases of “auxiliary charge” (steps S51 and S52), “constant current charge” (Yes in steps S52 to S55), and “constant voltage charge” (steps S56 to S58). In addition, in the graph shown in the upper part of FIG. 6, a graph which is expressed using a thick straight line and a curved line indicates the change in a current value which flows through secondary battery 20, and a graph which is expressed using a dotted curved line indicates the change in a voltage value of secondary battery 20. Table shown in lower part indicates operations in the respective phases of the charge state, electronic device software, and the charger (microcomputer control) from above. The charge state indicates a voltage and a current which are supplied according to the charge state of secondary battery 20, and the electronic device software indicates an instruction which is performed by device-side microcomputer 40 of electronic device 10. In addition, the charger (microcomputer control) indicates the operation of charger 30, and indicates the flow of a signal which is transmitted from device-side microcomputer 40 to charger-side microcomputer 50. Three phases “auxiliary charge”, “constant current charge”, and “constant voltage charge” appear in chronological order from the left side of the graph and the table of FIG. 6.

Phase 1: Auxiliary Charge

Phase 1 is auxiliary charge which is performed when the voltage of secondary battery 20 does not reach a voltage which enables quick charging.

Voltage detection section 14 monitors the voltage of secondary battery 20. When the state of secondary battery 20 is close to a dummy charge state in which charge is necessary like dummy charging voltage V1 (for example, 2.7 V), voltage detection section 14 provides a notification that charge is necessary to a user through the display monitor or the like of electronic device 10, which is not shown in the drawing. The user electrically connects electronic device 10 to charger (AC adaptor) 30 through cable K, and charge starts (step S51). When electronic device 10 is connected to charger 30, the voltage value of secondary battery 20, which is acquired in voltage detection section 14, is transmitted to device-side control circuit 41, and device-side control circuit 41 determines whether or not the voltage value is equal to or less than quick charging start voltage V2 (for example, 3.4 V) which will be described later (step S52).

When device-side control circuit 41 determines that the voltage value of secondary battery 20 is equal to or less than V2 (No in step S52), determination information is transmitted from command control section 44 on the side of electronic device 10 to command control section 52 on the side of charger 30 using a digital signal through second communication connection section D2. Command control section 52 causes power supply circuit 33 to be ON by outputting an instruction to power supply determination section 53. Further, a voltage of voltage value V5 (for example, 5 V) is supplied (positive voltage supply) from power supply circuit 33 to electronic device 10, and constant current control in which a current is supplied using a fixed small current I1 (for example, 0.1 A) as shown in the graph of FIG. 6 is performed. In the first exemplary embodiment, constant current control is performed by charge control section 15 of electronic device 10 using current I1.

When the voltage value of secondary battery 20 is equal to or less than V2, charger 30 performs positive voltage supply on electronic device 10 using voltage V5. However, in electronic device 10, the constant current control is performed using current I1, and thus it is possible to prevent deterioration of the performance of secondary battery 20. In addition, a small amount of heat generates on the side of electronic device 10 because charge is performed using small current I1, and thus it is possible to reduce the load of heat generation of electronic device 10. The above-described positive voltage supply simply indicates supply of fixed voltage V5 (for example, 5 V) from charger 30 to electronic device 10. In addition, the above-described constant current control indicates control performed using constant current I1 (for example, 0.1 A) or I2 (for example, 4 A), which will be described later, while monitoring the voltage of secondary battery 20.

Phase 2: Constant Current Charge

In phase 2, when device-side microcomputer 40 and charger-side microcomputer 50 determine that the voltage of secondary battery 20 is equal to or higher than quick charging start voltage V2 (Yes in step S52), charger 30 starts quick charging using constant current I2 (for example, 4.0 A).

When it is determined that the voltage of secondary voltage 20 is equal to or lower than constant voltage charge start voltage V3 (for example, 4.25 V) (No in step S53), device-side control circuit 41 transmits a command for starting charge using current I2 to command control section 52 on the side of charger 30 (step S54). Although power is supplied using constant voltage V5 on the side of charger 30 (step S61), charger-side microcomputer 50 determines whether or not the command is received from device-side microcomputer 40 (step S62). When charger-side microcomputer 50 determines that the command is received (Yes in step S62), power supply determination section 53 causes power supply circuit 33 to be OFF and causes charge control circuit 36 to be ON. Also, OFF of power supply circuit 33 is not particularly limited.

When charge control circuit 36 is in an ON state, the constant current control using current I2 from output section 35 is performed on secondary battery 20 through electrical path 16 of electronic device 10 (step S63). The above-described quick charging corresponds to level (1) expressed in the table of FIG. 6, and device-side control circuit 41 sends a quick charging request to the side of charger 30 because the voltage exceeds voltage V2. The side of charger 30 receives the request from electronic device 10, thereby being in a state which is converted to charge with current I2.

The constant current charge is quick charging in which, when the voltage of secondary battery 20 is equal to or lower than V3 (for example, 4.25 V), constant current control is performed on the side of charger 30 using current I2 and positive voltage supply is performed on secondary battery 20 using voltage V5. In addition, in the constant current charge, current I2, which is higher than current I1 of the auxiliary charge of phase 1, flows, thereby enabling the quick charging. Also, there is a case in which above-described voltage V3 is described as a prescribed voltage or a first voltage value and voltage V2 which is lower than voltage V3 is described as a second voltage value.

The important thing in phase 2 is that the quick charging starts when the voltage of secondary battery 20 becomes a chargeable voltage V2 and the quick charging stops using a voltage which is the prescribed voltage V3 in order to prevent the charge performance of secondary battery 20 from being deteriorated. Also, secondary battery 20 is monitored by electronic device 10, and the appropriate quick charging is possible by applying feedback.

Phase 3: Constant Voltage Charge

Phase 3 is constant voltage charge in which control is performed such that, when the voltage of secondary battery 20 according to quick charging is equal to or higher than constant voltage charge start voltage V3 (for example, 4.25 V) (Yes in step S53), the voltage of secondary battery 20 is converged to the constant voltage in the shape of full charging voltage V4 (for example, 4.34 V). In phase 3, the charge current is lowered in accordance with the voltage of secondary battery 20.

When device-side control circuit 41 determines that the voltage of secondary battery 20 is equal to or higher than V3 (Yes in step S53), device-side control circuit 41 transmits a command to end the quick charging of current I2 to command control section 52 (step S55). Command control section 52 which receives the command (Yes in step S64), transmits an instruction to power supply determination section 53 and such that power supply circuit 33 is caused to be ON while charge control circuit 36 is caused to be OFF, charger 30 performs positive voltage supply of voltage V5 (step S61), and the constant voltage charge control is performed on the side of electronic device 10 (step S56). The constant voltage charge is at level (2) which is expressed in the Table of FIG. 6.

The constant voltage charge starts at current I3 (for example, 1 A) as illustrated in the graph of FIG. 6. Voltage detection section 14 of electronic device 10 usually monitors the voltage of secondary battery 20, and lowers the charge current in a range in which the voltage of secondary battery 20 does not exceed full charging voltage V4 (for example, 4.25 V). Further, when it is determined that charge current is equal to or lower than 14 (for example, 50 mA and Yes in step S57), electronic device 10 completes the charge (step S58). Full charging voltage V4 is at level (3) of FIG. 6, and charge current I4 is at level (4) of FIG. 6.

The important thing in phase 3 is that full charging voltage V4 should not be exceeded. Therefore, voltage detection section 14 monitors the voltage of secondary battery 20, and controls the current of electronic device 10 in real time. That is, the accuracy of charge control in electronic device 10 proceeds, current control is performed from current I3 toward current I4 in which a current smaller than current I2 when quick charging is performed, and thus it is possible to suppress the generation of heat due to the charge of electronic device 10.

FIG. 7 is a table for comparing the related art with the present invention, for example, the first exemplary embodiment. The related art is a general technology (well-known art) hitherto which includes, for example, PTL 1 and in which all controls are performed on the side of electronic device 10.

The chief difference between the first exemplary embodiment (hybrid type) and the related art is level (2) of phase 2: constant current charge (high current quick charging), that is, the constant current control of high current I2 is performed on the side of charger 30 and the charging voltage and the charge current flow through electrical path 16 on the side of electronic device 10. As in the related art, all the charge is performed by electronic device 10, the amount of heat generation increases together with a current value in, in particular, the smart phone or the like, and thus there is a possibility that the temperature of electronic device 10 increases over the allowable temperature. In the present invention, quick charging using a high current is performed by charger 30, current control using a small current which requires higher precision is performed by electronic device 10, and thus it is possible to suppress the heat generation of electronic device 10. Further, the voltage of secondary battery 20 is monitored in real time, the current control is precisely performed on the side of electronic device 10 based on the battery information, and thus it is possible to prevent the performance of secondary battery 20 from being deteriorated.

### Second Exemplary Embodiment

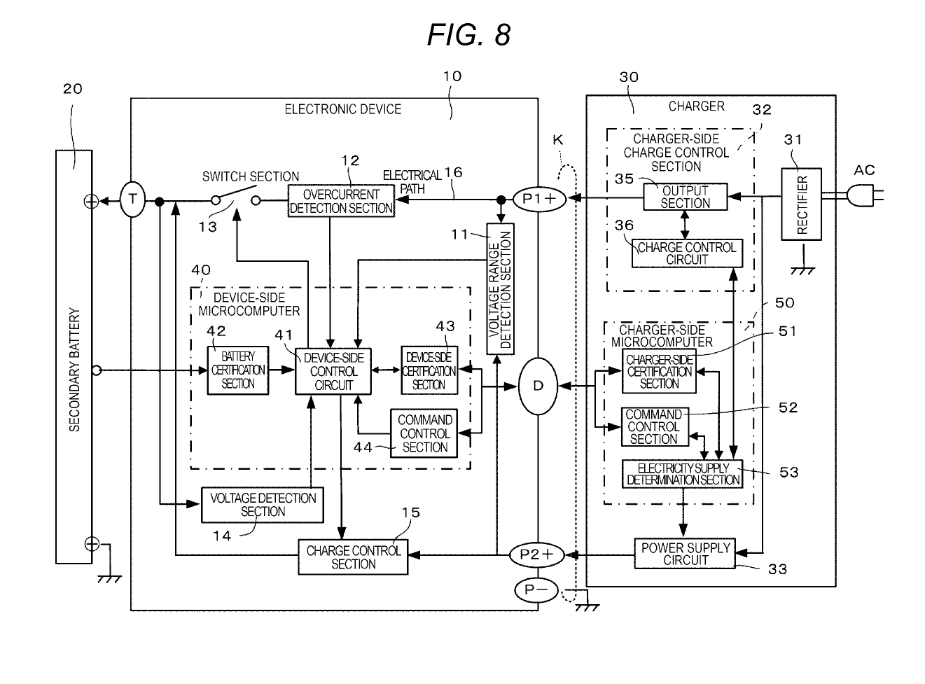

FIG. 8 is a block diagram illustrating an example of an electronic device according to a second exemplary embodiment of the present invention. Hereinafter, in the respective embodiments, the same reference numerals are attached to the same components as in the first exemplary embodiment and the description thereof will not be repeated.

In the second exemplary embodiment, in order to simplify connection parts, a configuration of communication connection section D, in which first communication connection section D1 and second communication connection section D2 in the first exemplary embodiment are integrated, is used. That is, reception of first certification data, transmission of second certification data, and transmission and reception of a command are performed using communication connection section D, which is a common interface, between device-side microcomputer 40 and charger-side microcomputer 50. With regard to the transmission and reception of a signal, it is possible to transmit and receive, for example, a data signal having common electric specifications in a time division manner.

### Third Exemplary Embodiment

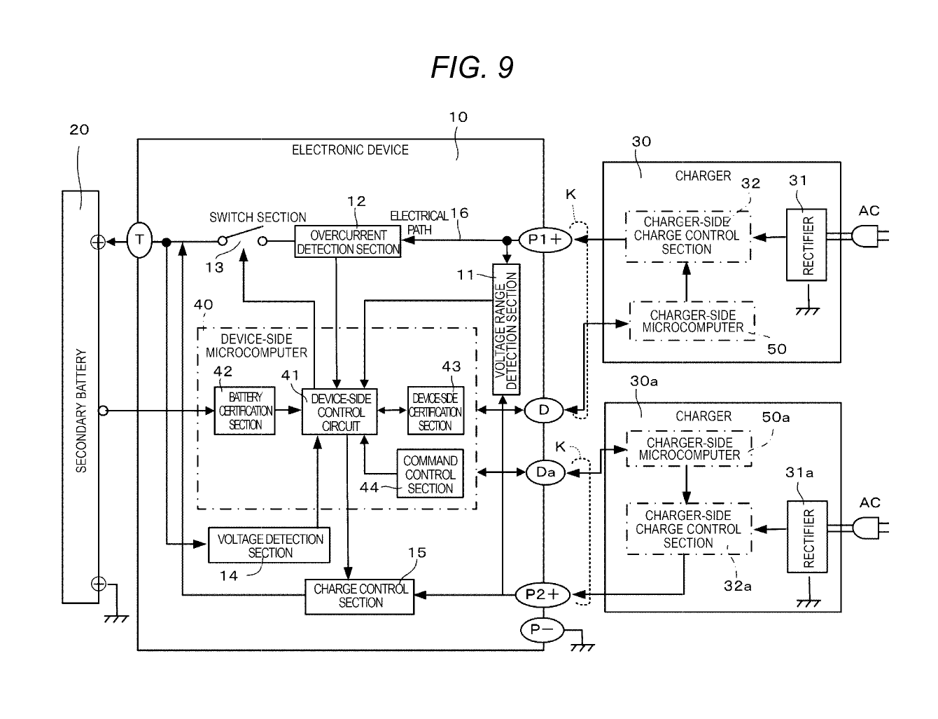

FIG. 9 is a block diagram illustrating an example of electronic device according to a third exemplary embodiment of the present invention. Also, in view of the drawing, the detailed configurations of charger-side charge control sections 32 and 32a and charger-side microcomputers 50 and 50a of chargers 30 and 30a are omitted.

Although secondary battery 20 is charged by a single charger 30 in the first exemplary embodiment, charge is performed by plural chargers 30 and 30a in the third exemplary embodiment. In addition, it is possible for respective chargers 30 and 30a to certify electronic device 10 and to transmit and receive a command through respective communication connection sections D and Da. That is, charger 30 electrically connects first charge connection section P1 to communication connection section D, and charger 30a electrically connects second charge connection section P2 to communication connection section Da. Further, power is supplied to electronic device 10 using only charger-side control sections 32 and 32a without power supply circuit 33. For example, charger-side microcomputer 50a outputs an instruction to charger-side charge control section 32a by performing certification, transmission and reception of a command, or determination, and power is supplied to charge control section 15 by charger 30a through second charge connection section P2.

Further, although it is possible to supply power to electronic device 20 by either charger 30 (or charger 30a) according to the charge phase (the auxiliary charge, the constant current charge, or the constant voltage charge), it is possible to supply power at the same time. That is, it is possible to charge secondary battery 20 using charging power supplied to any one of or both of first charge connection section P1 and second charge connection section P2. In addition, although electrical connection which is individually performed is described above, it is possible to standardize the transmission and reception sections of device-side microcomputer 40 and charger-side microcomputers 50 and 50a using, for example, time division multiplexing. When secondary battery 20 is charged by plural chargers 30 and 30a, the loads of respective chargers 30 and 30a are reduced.

Hereinafter, an example of the relationship between the use of chargers 30 and 30a and a charge phase will be described.

(1) Phase 2 (Constant Current Charge):

Power is supplied from charger-side charge control section 32 of charger 30 and charger-side charge control section 32a of charger 30a. Although both chargers 30 and 30a are operated, it is desired that charger 30 is mainly operated and charging power, which is supplied from charger 30 to secondary battery 20, is greater than charging power which is supplied from charger 30a. In addition, there is a case in which charger 30a is not operated (on and off control of charger 30a).

(2) Phase 1 (Auxiliary Charge) and Phase 3 (Constant Voltage Charge):

Power is not supplied from charger 30 and power is supplied from charger 30a, and secondary battery 20 is charged through second charge connection section P2 and charge control section 15 in the third exemplary embodiment. That is, device-side microcomputer 40 causes switch section 13 to be OFF, and causes at least the output of charge control section 15 to be ON.

### Fourth Exemplary Embodiment

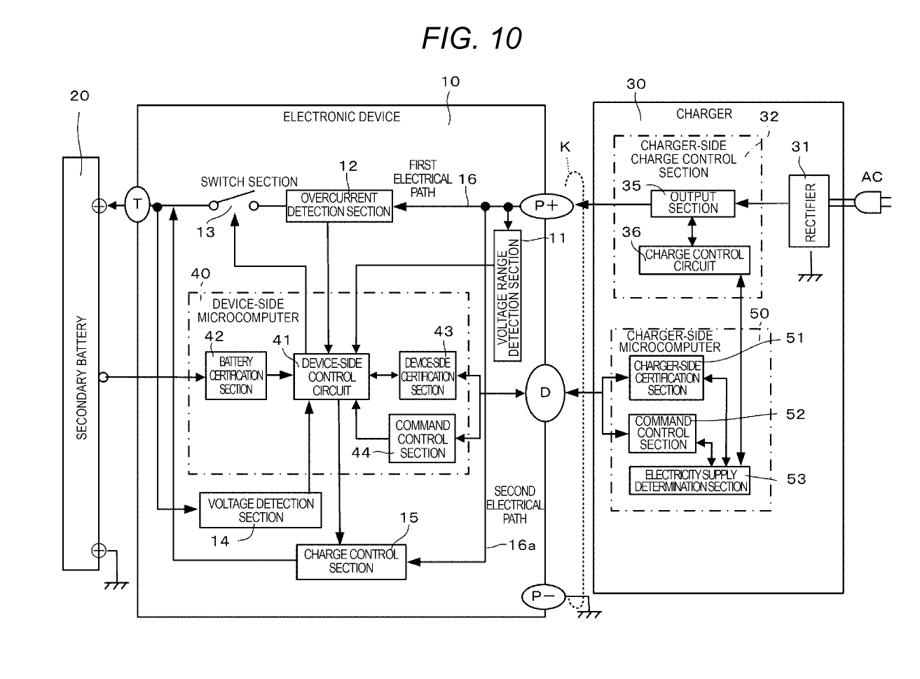

FIG. 10 is a block diagram illustrating an example of an electronic device according to a fourth exemplary embodiment of the present invention.

The fourth exemplary embodiment is different from the first exemplary embodiment in that communication connection section D is standardized similarly to the second exemplary embodiment, in that first charge connection section P1 and second charge connection section P2 become standardized charge connection section P, and in that power supply circuit 33 on the side of charger 30 is removed. In addition, power, supplied from charger 30 through charge connection section P, is charged from charge control section 15 to secondary battery 20 through first electrical path 16 and second electrical path 16a which is branched off from first electrical path 16. In power supplied from both electrical paths 16 and 16a, power supplied from first electrical path 16 is principal and is greater than charging power supplied from second electrical path 16a. When electrical connection between electronic device 10 and charger 30 is simplified, it is easy to handle, and thus there is a possibility that charger 30 is simplified.

In addition, electrical path 16, which is described from the first to third exemplary embodiments, is described as first electrical path 16. In the fourth exemplary embodiment, device-side microcomputer 40 controls switch section 13 and charge control section 15 by performing exchange with charger-side microcomputer 50, and thus it is possible to charge secondary battery 20 through any one of or both switch section 13 and charge control section 15.

Hereinafter, an example of the relationship between switch between first electrical path 16 and second electrical path 16a and charge phase will be described.

(1) Phase 2 (Constant Current Charge):

Although switch section 13 is caused to be ON and power is supplied through first electrical path 16, power may be supplied through second electrical path 16a at the same time. When both electrical paths 16 and 16a are in a conductive state, it is desired that power supplied from first electrical path 16 is principal and that charging power, which is supplied from first electrical path 16 to secondary battery 20, is greater than charging power, which is supplied from second electrical path 16a.

(2) Phase 1 (Auxiliary Charge) and Phase 3 (Constant Voltage Charge):

Switch section 13 is caused to be OFF based on an instruction of device-side microcomputer 40, and secondary battery 20 is charged from charge connection section P through second electrical path 16a and charge control section 15.

### Fifth Exemplary Embodiment

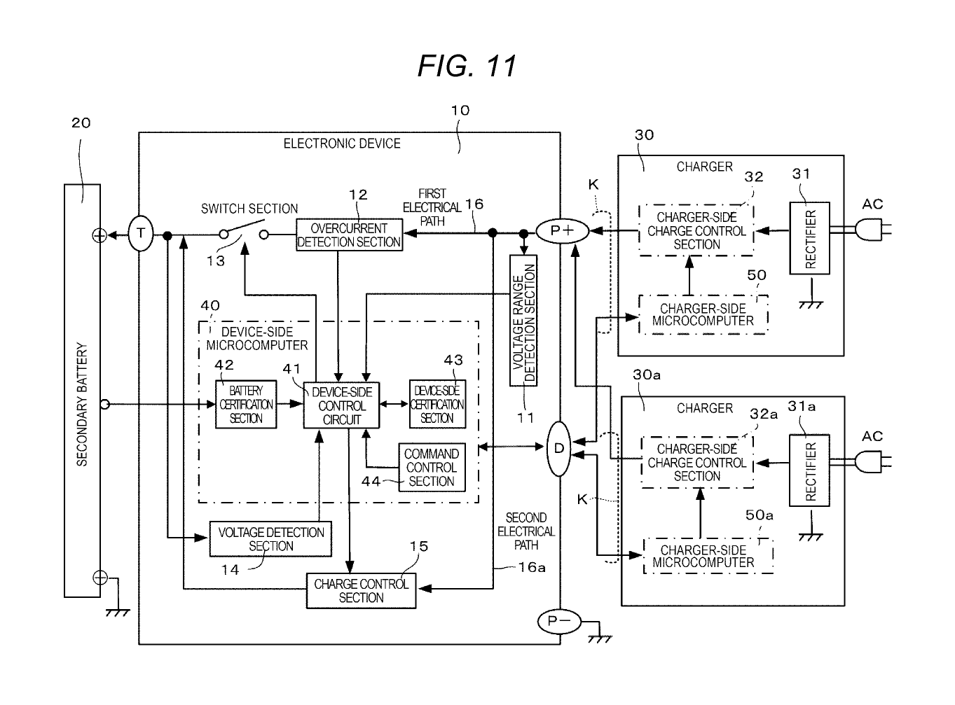

FIG. 11 is a block diagram illustrating an example of an electronic device according to a fifth exemplary embodiment of the present invention.

The fifth exemplary embodiment is another embodiment of the fourth exemplary embodiment, and secondary battery 20 is charged using plural chargers 30 and 30a similarly to the third exemplary embodiment. Power is supplied to electronic device 10 by charger-side charge control section 32 of charger 30 and charger charge control section 32a of charger 30a, and certification and transmission and reception of a command are performed by charger-side microcomputer 50 of charger 30 and charger-side microcomputer 50a of charger 30a. When secondary battery 20 is charged by plural chargers 30 and 30a, the loads of respective chargers 30 and 30a are reduced.

Further, although it is possible to supply power to electronic device 20 using any one of charger 30 (and charger 30a) according to charge phase (auxiliary charge, constant current charge, or constant voltage charge), it is possible to supply power at the same time. In addition, although electrical connection, which is individually performed, has been described above, it is possible to standardize the transmission and reception section between device-side microcomputer 40 and charger-side microcomputers 50 and 50a using, for example, time division multiplexing or the like.

Hereinafter, an example of the relationship between the use of charger 30 and charger 30a and charge phase will be descried.

(1) Phase 2 (Constant Current Charge):

Power is supplied from charger-side charge control section 32 of charger 30 and charger-side charge control section 32a of charger 30a. The output ratio of both chargers 30 and 30a is a design item which can be appropriately selected. In addition, one of chargers 30 and 30a may perform output. When both electrical paths 16 and 16a are in a conductive state, power, which is supplied from first electrical path 16, is principal. Although it is desired that charging power, which is supplied from first electrical path 16 to secondary battery 20, is greater than charging power, which is supplied from second electrical path 16a, the same current value may be used.

Also, in the third exemplary embodiment of FIG. 9, two independent charge connection sections P1 and P2 are provided in electronic device 10, and two chargers 30 and 30a respectively correspond to charge connection sections P1 and P2. Therefore, in phase 2, it is prepared to provide the master-servant relationship (for example, charger 30 principally performs charge) between two chargers 30 and 30a, or to actively cause any one of the chargers (for example, on or off control for charger 30a) to be ON or OFF. However, in the embodiment, only single charge connection section P, which is acquired by standardizing first charge connection section P1 and second charge connection section P2, is provided, and thus power supplied from both chargers 30 and 30a is finally synthesized at charge connection section P. Therefore, in the embodiment, it is not essentially prepared to provide the master-servant relationship between two chargers 30 and 30a or to actively cause any one of the chargers to be ON or OFF.

(2) Phase 1 (Auxiliary Charge) and Phase 3 (Constant Voltage Charge):

Secondary battery 20 is charged from charge connection section P through second electrical path 16a and charge control section 15. That is, device-side microcomputer 40 causes switch section 13 to be OFF, and causes at least output of charge control section 15 to be ON.

### Sixth Exemplary Embodiment

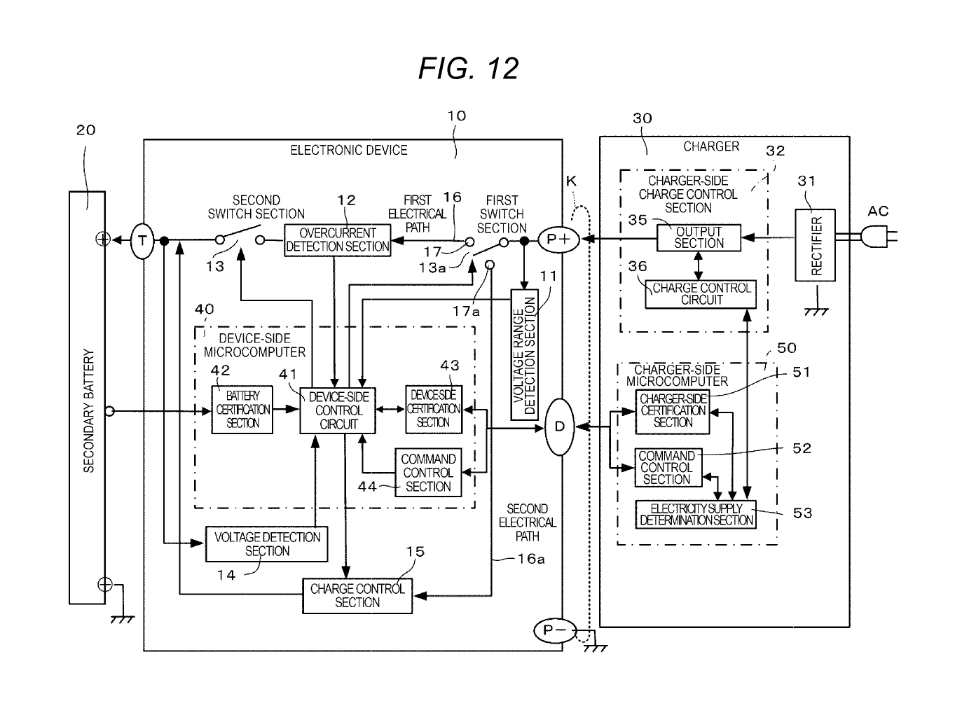

FIG. 12 is a block diagram illustrating an example of an electronic device according to a sixth exemplary embodiment of the present invention.

The sixth exemplary embodiment is another embodiment of the fourth exemplary embodiment. First switch section 13a is added to first electrical path 16, and switch section 13 in the above-described embodiment functions as second switch section 13. In the first exemplary embodiment, switch, which is performed between ON and OFF of charge control section 15 based on the instruction of device-side microcomputer 40, has been described. However, in the sixth exemplary embodiment, switch of first switch section 13a is performed based on the instruction of device-side microcomputer 40. That is, first switch section 13a switches between contact 17 on the side of first electrical path 16 and contact 17a on the side of second electrical path 16a, thereby enabling first electrical path 16, which is connected to charge connection section P, to be branched. Further, it is possible to charge secondary battery 20 through any one of charge control section 15 and second switch section 13 based on switch performed by first switch section 13a.

The constant voltage charge of phase 3 according to the first exemplary embodiment will be described below. “Device-side control circuit 41 transmits a command to end the quick charging of current I2 to command control section 52, causes charge control circuit 36 to be OFF and causes power supply circuit 33 to be ON, and charger 30 supplies a positive voltage of voltage V5”. In the sixth exemplary embodiment, charging power is supplied to electronic device 10 through a single charge connection section P. Accordingly, device-side control circuit 41 switches over first switch section 13a such that charge connection section P and second electrical path 16a are in a conductive state, and thus power is supplied to secondary battery 20 through charge control section 15. When first switch section 13a is switched over, it is possible to secure a definite power supply path.

Hereinafter, an example of the relationship between the switch of first switch section 13a and charge phase and certification will be described.

(1) Phase 2 (Constant Current Charge):

First switch section 13a is conducted to contact 17 and second switch section 13 is ON, and thus secondary battery 20 is charged through first electrical path 16.

(2) Phase 1 (Auxiliary Charge) and Phase 3 (Constant Voltage Charge):

First switch section 13a is conducted to contact 17a and second switch section 13 is caused to be OFF, and secondary battery 20 is charged through second electrical path 16a.

(3) Bad Certification or the Like:

Both first switch section 13a and second switch section 13 are in an OFF state.

### Seventh Exemplary Embodiment

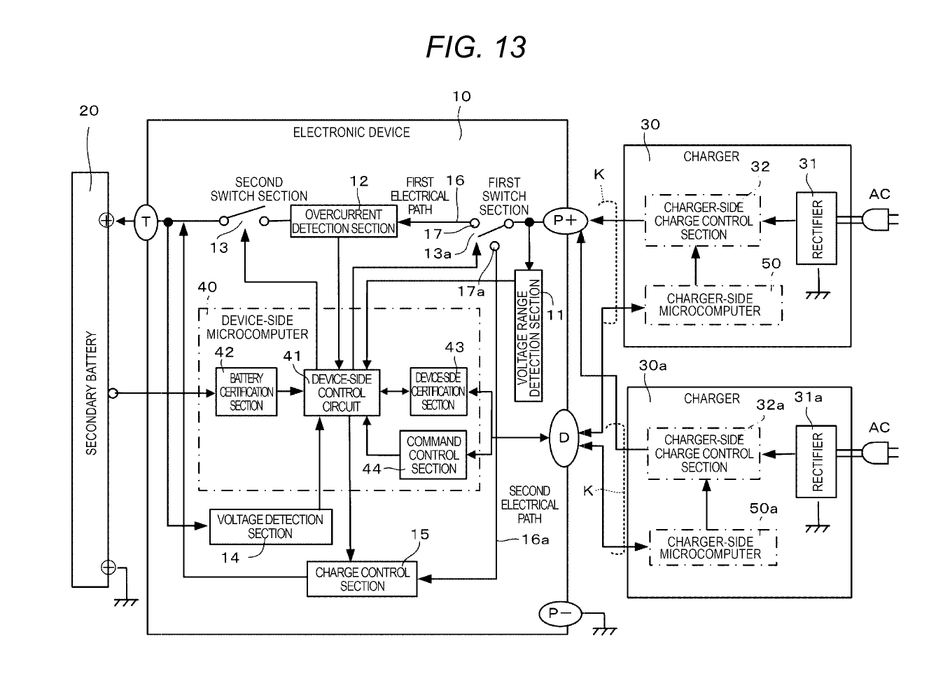

FIG. 13 is a block diagram illustrating an example of an electronic device according to a seventh exemplary embodiment of the present invention.

The seventh exemplary embodiment is another embodiment of the sixth exemplary embodiment, and plural chargers 30 and 30a charge secondary battery 20. Power is supplied to electronic device 10 by charger-side charge control section 32 of charger 30 and charger-side charge control section 32a of charger 30a, and certification and transmission and reception of a command are performed by charger-side microcomputer 50 of charger 30 and charger-side microcomputer 50a of charger 30a. When secondary battery 20 is charged by plural chargers 30 and 30a, the loads of respective chargers 30 and 30a are reduced.

Further, although it is possible to supply power to electronic device 20 using any one of charger 30 (and charger 30a) according to a charge phase (auxiliary charge, constant current charge, or constant voltage charge), it is possible to supply power at the same time. In addition, although electrical connection, which is individually performed, has been described above, it is possible to standardize the transmission and reception section between device-side microcomputer 40 and charger-side microcomputers 50 and 50a using, for example, time division multiplexing or the like.

Hereinafter, an example of the relationship between the use of charger 30 and charger 30a and charge phase will be descried. Also, the operations of first switch section 13a and second switch section 13 are the same as in the sixth exemplary embodiment.

(1) Phase 2 (Constant Current Charge):

Power is supplied from charger-side charge control section 32 of charger 30 and charger-side charge control section 32a of charger 30a. The output ratio of both chargers 30 and 30a is a design item which can be appropriately selected. In addition, one of chargers 30 and 30a may perform output. When both electrical paths 16 and 16a are in a conductive state, power, which is supplied from first electrical path 16, is principal. Although it is desired that charging power, which is supplied from first electrical path 16 to secondary battery 20, is greater than charging power, which is supplied from second electrical path 16a, the same current value may be used.

(2) Phase 1 (Auxiliary Charge) and Phase 3 (Constant Voltage Charge):

Secondary battery 20 is charged through charge connection section P and charge control section 15. That is, device-side microcomputer 40 causes first switch section 13a and contact 17a on the side of second electrical path 16a to be in a conductive state, and supplies charging power through second electrical path 16a.

### Eighth Exemplary Embodiment

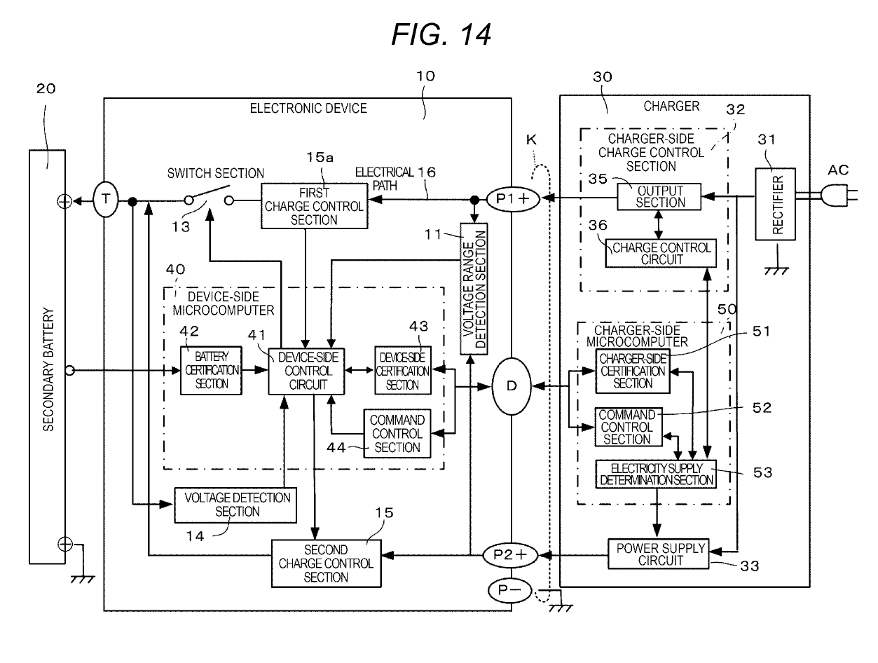

FIG. 14 is a block diagram illustrating an example of an electronic device according to an eighth exemplary embodiment of the present invention.

In the first to seventh exemplary embodiments, overcurrent detection section 12 is provided on electrical path 16. However, from the eighth exemplary embodiment, overcurrent detection section 12 is changed into first charge control section 15a. The eighth exemplary embodiment has the same electrical connection between electronic device 10 and charger 30 according to the second exemplary embodiment. In addition, charge control section 15 will be described as second charge control section 15.

Although overcurrent detection section 12 simply detects the current value, overcurrent detection section 12 includes first charge control section 15a and second charge control section 15, and thus overcurrent detection section 12 can adjust the supply of power. That is, first charge control section 15a and second charge control section 15 can determine the highest current value which is possible with each other based on the exchange between device-side microcomputer 40 and charger-side microcomputer 50. Basically, first charge control section 15a is the main subject, and supplies greater charging power than second charge control section 15. For example, first charge control section 15a causes a current of 2 A to flow, and second charge control section 15 causes a current of 1 A to flow. Meanwhile, the same current value may be possible, and, in this case, second charge control section 15 may be the main subject.

Hereinafter, an example of the relationship between the operations of first charge control section 15a and second charge control section 15 and charge phase will be described.

(1) Phase 2 (Constant Current Charge):

First charge control section 15a and second charge control section 15 are operated by the instruction of device-side microcomputer 40, and thus secondary battery 20 is charged. Although first charge control section 15a and second charge control section 15 are operated, first charge control section 15a is mainly operated. In addition, there is a case in which second charge control section 15 is not operated.

(2) Phase 1 (Auxiliary Charge) and Phase 3 (Constant Voltage Charge):

Power is not supplied from first charge control section 15a and power is supplied from second charge control section 15, and secondary battery 20 is charged through second charge connection section P2 and second charge control section 15. That is, device-side microcomputer 40 causes at least the outputs of switch section 13 and first charge control section 15a to be OFF, and causes at least the output of second charge control section 15 to be an ON state.

### Ninth Exemplary Embodiment

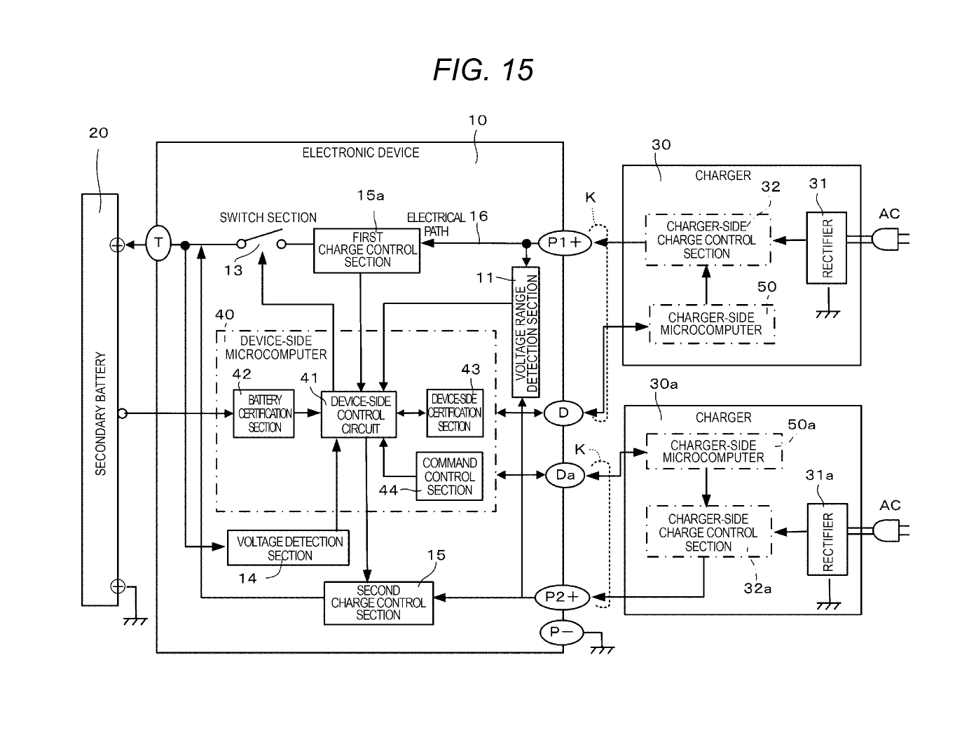

FIG. 15 is a block diagram illustrating an example of an electronic device according to a ninth exemplary embodiment of the present invention.

The ninth exemplary embodiment is another embodiment of the eighth exemplary embodiment, and secondary battery 20 is charged by plural chargers 30 and 30a. Power is supplied to electronic device 10 by charger-side charge control section 32 of charger 30 and charger-side charge control section 32a of charger 30a, and certification and transmission and reception of a command are performed by charger-side microcomputer 50 of charger 30 and charger-side microcomputer 50a of charger 30a. When secondary battery 20 is charged by plural chargers 30 and 30a, the loads of respective chargers 30 and 30a are reduced.

Further, although it is possible to supply power to electronic device 20 by any one of charger 30 (and charger 30a) according to the charge phase (auxiliary charge, constant current charge, or constant voltage charge), it is possible to supply power at the same time. That is, it is possible to charge secondary battery 20 using charging power which is supplied from any one of or both of first charge connection section P1 and second charge connection section P2. In addition, although it has been described that electrical connection is individually performed, it is possible to standardize transmission and reception sections between device-side microcomputer 40 and charger-side microcomputers 50 and 50a using, for example, time division multiplexing.

Hereinafter, an example of the relationship between the use of charger 30 and charger 30a and charge phase will be described. Also, the operations of first charge control section 15a and second charge control section 15 are the same as in the eighth exemplary embodiment.

(1) Phase 2 (Constant Current Charge):

Power is supplied from charger-side charge control section 32 of charger 30 and charger-side charge control section 32a of charger 30a. Although both chargers 30 and 30a are operated, it is desired that charger 30 is mainly operated and charging power supplied from charger 30 to secondary battery 20 is greater than charging power supplied from charger 30a. In addition, there is a case in which charger 30a is not operated.

(2) Phase 1 (Auxiliary Charge) and Phase 3 (Constant Voltage Charge):

Power is not supplied from charger 30 and power is supplied from charger 30a, and thus secondary battery 20 is charged through second charge connection section P2 and second charge control section 15. That is, device-side microcomputer 40 causes at least outputs of switch section 13 and first charge control section 15a to be OFF, and causes at least output of second charge control section 15 to be in an ON state.

### Tenth Exemplary Embodiment

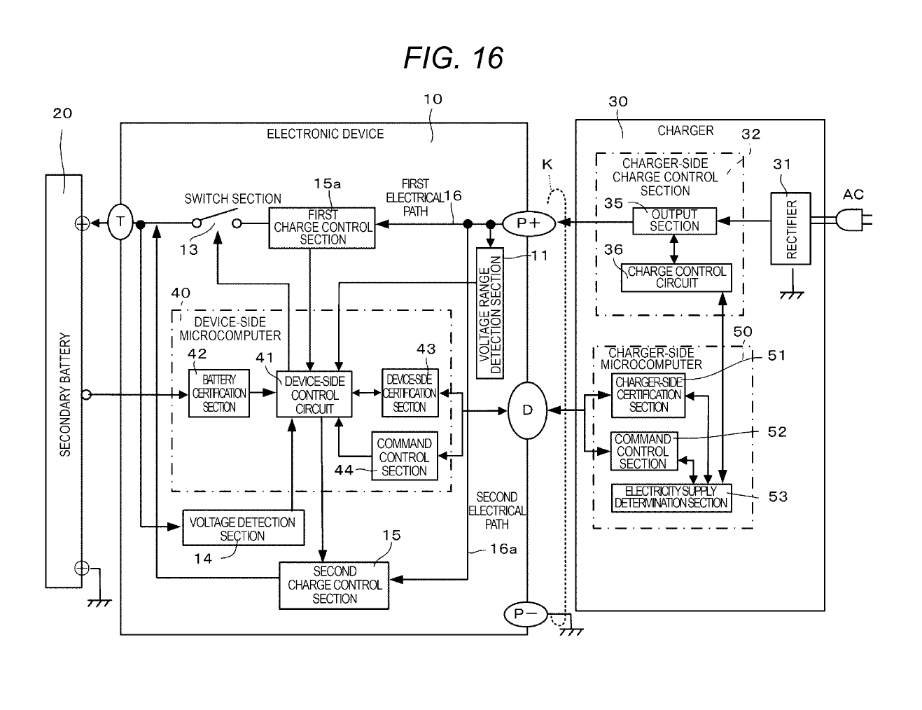

FIG. 16 is a block diagram illustrating an example of an electronic device according to a tenth exemplary embodiment of the present invention.

Although the tenth exemplary embodiment is another embodiment of the eighth exemplary embodiment, the tenth exemplary embodiment is the same as the fourth exemplary embodiment in that charge connection section P is standardized and second electrical path 16a is branched off from first electrical path 16.

In the tenth exemplary embodiment, device-side microcomputer 40 controls switch section 13 and second charge control section 15 based on the exchange with charger-side microcomputer 50, and thus it is possible to charge secondary battery 20 though any one of or both switch section 13 and second charge control section 15. In addition, battery certification section 42 and command control section 44 of device-side microcomputer 40 perform exchange with charger-side microcomputer 50, thereby determined that, for example, first charge control section 15a causes a current of 2 A to flow and second charge control section 15 causes a current of 1 A to flow. Further, charger-side microcomputer 50 can receive the current and output section 35 of charger 30 can cause a current of 3 A to flow.

Hereinafter, an example of the relationship between the switch of first electrical path 16 and second electrical path 16a and charge phase will be described.

(1) Phase 2 (Constant Current Charge):

Although switch section 13 is ON and power is supplied through first electrical path 16 and first charge control section 15a, power may be supplied through second electrical path 16a and second charge control section 15 at the same time. When both electrical paths 16 and 16a are in a conductive state, the supply of charging power from first electrical path 16 and first charge control section 15a is principal.

(2) Phase 1 (Auxiliary Charge) and Phase 3 (Constant Voltage Charge):

At least the outputs of switch section 13 and first charge control section 15a is caused to be OFF by the instruction of device-side microcomputer 40, and secondary battery 20 is charged through second electrical path 16a and second charge control section 15.

### Eleventh Exemplary Embodiment

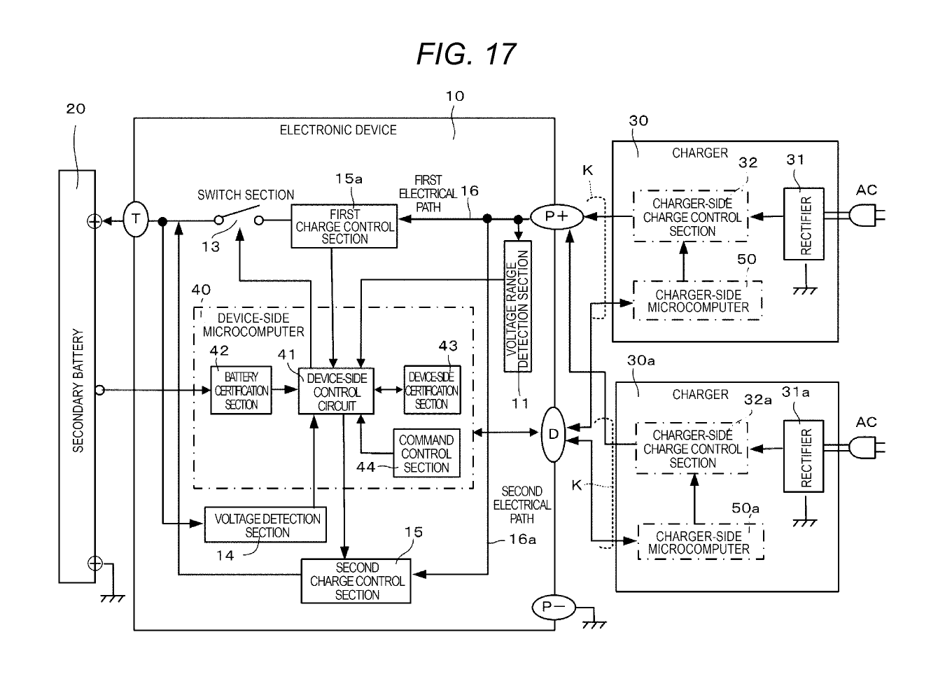

FIG. 17 is a block diagram illustrating an example of an electronic device according to an eleventh exemplary embodiment of the present invention.

The eleventh exemplary embodiment is another embodiment of the tenth exemplary embodiment, and secondary battery 20 is charged by plural chargers 30 and 30a. Power is supplied to electronic device 10 by charger-side charge control section 32 of charger 30 and charger-side charge control section 32a of charger 30a, and certification and transmission and reception of a command are performed by charger-side microcomputer 50 of charger 30 and charger-side microcomputer 50a of charger 30a. When secondary battery 20 is charged by plural chargers 30 and 30a, the loads of respective chargers 30 and 30a are reduced.

Further, although it is possible to supply power to electronic device 20 by any one of charger 30 (and charger 30a) according to the charge phase (auxiliary charge, constant current charge, or constant voltage charge), it is possible to supply power at the same time. In addition, although it has been described that electrical connection is individually performed, it is possible to standardize transmission and reception sections between device-side microcomputer 40 and charger-side microcomputers 50 and 50a using, for example, time division multiplexing.

Hereinafter, an example of the relationship between the use of charger 30 and charger 30a and charge phase will be described. Also, conduction of first electrical path 16 and second electrical path 16a is the same as in a tenth exemplary embodiment.

(1) Phase 2 (Constant Current Charge):

Power is supplied from charger-side charge control section 32 of charger 30 and charger-side charge control section 32a of charger 30a. The output ratio of both chargers 30 and 30a is a design item which can be appropriately selected. In addition, one of chargers 30 and 30a may perform output. When both electrical paths 16 and 16a are in a conductive state, power, which is supplied from first electrical path 16, is principal. Although it is desired that charging power, which is supplied from first electrical path 16 to secondary battery 20, is greater than charging power, which is supplied from second electrical path 16a, the same current value may be used.

(2) Phase 1 (Auxiliary Charge) and Phase 3 (Constant Voltage Charge):

The outputs of switch section 13 and first charge control section 15a are caused to be OFF and secondary battery 20 is charged from second electrical path 16a through second charge control section 15.

In present invention, the first, the second . . . ,. which are used for, for example, first charge connection section P1 and second charge connection section P2, are terms used for explanation, and are not particularly limited.

Although charge connection section P and communication connection section D are described above as respective configurations, charge connection section P and communication connection section D may be in common. There is a possibility that a configuration is simplified through standardization, thereby lading to reduction in costs. Further, it is possible to configure a three-terminal regulator in which charge connection section P and communication connection section D are respective terminals and, for example, a ground terminal is separately provided.

Although electrical connection between electronic device 10 and charger 30 using cable K has been described, terminals (for example, metal terminals) may be electrically connected directly without cable K.

Also, the present invention is not limited to the above-described embodiment, and appropriately modified or improved. In addition, if each of the components in the above-described embodiments can accomplish the present invention, the material, the shape, the dimension, the numerical value, the form, the number, the placement position, and the like thereof are arbitrary and are not limited.

The electronic device according to the present invention can be applied for the purpose of safely charging the secondary battery of a mobile phone such as a smart phone, a mobile terminal such as a tablet, a digital camera, a portable personal computer, a wireless device, or the like.

What is claimed is:

1. An electronic device comprising:
first and second charge connection sections that can be connected to at least one external charger;
a battery terminal that can be connected to a secondary battery when the detachable secondary battery is attached;
a switch section that can switch conduction and cut-off of an electrical path which electrically connects between the first charge connection section and the battery terminal;
a communication connection section that can at least receive first certification data and transmit second certification data to and from the at least one external charger; and
a charge control section that can output at least a part of charging power, which is supplied from the second charge connection section, to the secondary battery,
wherein the switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and
wherein the secondary battery can be charged using the charging power which is supplied to any one of the first and second charge connection sections.

2. An electronic device comprising:
first and second charge connection sections that can be connected to at least one external charger;
a battery terminal that can be connected to a secondary battery when the detachable secondary battery is attached;
a switch section that can switch conduction and cut-off of an electrical path which electrically connects between the first charge connection section and the battery terminal;
a communication connection section that can at least receive first certification data and transmit second certification data to and from the at least one external charger; and
a charge control section that can output at least a part of charging power, which is supplied from the second charge connection section, to the secondary battery,
wherein the switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and
wherein the secondary battery can be charged using the charging power which is supplied from the first and second charge connection sections at the same time.

3. The electronic device of claim 2,
wherein the charging power which is supplied from the first charge connection section is greater than the charging power which is supplied from the second charge connection section.

4. The electronic device of claim 1,
wherein at least command data or message data can be transmitted and received through the communication connection section, and
wherein the charging power is supplied to at least one of the first and second charge connection sections based on the transmitted command data or message data.

5. An electronic device comprising:
a charge connection section that can be connected to at least one external charger;
a battery terminal that can be connected to a secondary battery when the detachable secondary battery is attached;
a first switch section that enables an electrical path which is connected to the charge connection section to be branched;
a second switch section that can switch conduction and cut-off of the electrical path which electrically connects between the first switch section and the battery terminal;
a communication connection section that can at least receive first certification data and transmit second certification data to and from the at least one external charger; and
a charge control section that can output at least a part of charging power, which is supplied from the charge connection section through the first switch section, to the secondary battery,
wherein the second switch section can be electrically conducted when the first certification data, which is received by the electronic device, is prescribed data and when a charging voltage, which is applied to the charge connection section after the electronic device transmits the second certification data, is included in a prescribed range, and cannot be electrically conducted at least when the received first certification data is not the prescribed data, and
wherein the secondary battery can be charged through any one of the charge control section and the second switch section.

6. The electronic device of claim 5,
wherein at least command data or message data can be transmitted and received through the communication connection section, and
wherein the charging power is supplied to the secondary battery through any one of the charge control section and the second switch section in response to the transmitted command data or message data.

7. An electronic device comprising:
a charge connection section that can be connected to at least one external charger;
a battery terminal that can be connected to a secondary battery when the detachable secondary battery is attached;
a switch section that can switch conduction and cut-off of a first electrical path which electrically connects between the charge connection section and the battery terminal;
a communication connection section that can at least receive first certification data and transmit second certification data to and from the at least one external charger; and
a charge control section that can output at least a part of charging power, which is supplied from the charge connection section through a second electrical path which electrically connects between the charge connection section and the battery terminal, to the secondary battery,
wherein the switch section can be electrically conducted when the first certification data, which is received by the electronic device, is prescribed data and when a charging voltage, which is applied to the charge connection section after the electronic device transmits the second certification data, is included in a prescribed range, and cannot be electrically conducted at least when the received first certification data is not the prescribed data, and
wherein the secondary battery can be charged through at least one of the charge control section and the switch section.

8. The electronic device of claim 7,
wherein at least command data or message data can be transmitted and received through the communication connection section, and
wherein the charging power is supplied to the secondary battery through any one of the charge control section and the switch section in response to the transmitted command data or message data.

9. An electronic device comprising:
first and second charge connection sections that can be connected to at least one external charger;
a battery terminal that can be connected to a secondary battery when the detachable secondary battery is attached;
a first charge control section that can output at least a part of charging power, which is supplied from the first charge connection section, to the secondary battery;
a switch section that can switch conduction and cut-off of an electrical path which electrically connects between the first charge control section and the battery terminal;
a communication connection section that can at least receive first certification data and transmit second certification data to and from the at least one external charger; and
a second charge control section that can output at least a part of charging power, which is supplied from the second charge connection section, to the secondary battery,
wherein the switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and
wherein the secondary battery can be charged using the charging power which is supplied to any one of the first and second charge connection sections.

10. An electronic device comprising:
first and second charge connection sections that can be connected to at least one external charger;
a battery terminal that can be connected to a secondary battery when the detachable secondary battery is attached;
a first charge control section that can output at least a part of charging power which is supplied from the first charge connection section to the secondary battery;
a switch section that can switch conduction and cut-off of an electrical path which electrically connects between the first charge control section and the battery terminal;
a communication connection section that can at least receive first certification data and transmit second certification data to and from the at least one external charger; and
a second charge control section that can output at least a part of charging power which is supplied from the second charge connection section to the secondary battery,
wherein the switch section can be electrically conducted when the first certification data, which is received by the electronic device, is prescribed data and when a charging voltage, which is applied to the first charge connection section after the electronic device transmits the second certification data, is included in a prescribed range, and cannot be electrically conducted at least when the received first certification data is not the prescribed data, and
wherein the secondary battery can be charged using the charging power which is supplied from the first and second charge connection sections at the same time.

11. The electronic device of claim 10,
wherein the charging power which is supplied from the first charge connection section is greater than the charging power which is supplied from the second charge connection section.

12. The electronic device of claim 9,
wherein at least command data or message data can be transmitted and received through the communication connection section, and
wherein the charging power is supplied to at least one of the first and second charge connection sections based on the transmitted command data or message data.

13. An electronic device comprising:
a charge connection section that can be connected to at least one external charger;
a battery terminal that can be connected to a secondary battery when the detachable secondary battery is attached;
a first charge control section that can output at least a part of charging power supplied from the charge connection section to the secondary battery;
a switch section that can switch conduction and cut-off of a first electrical path which electrically connects between the charge connection section and the battery terminal;
a communication connection section that can at least receive first certification data and transmit second certification data to and from the at least one external charger; and
a second charge control section that can output at least a part of charging power, which is supplied from the charge connection section through a second electrical path which electrically connects between the charge connection section and the battery terminal, to the secondary battery,
wherein the switch section can be electrically conducted when the first certification data, which is received by the electronic device, is prescribed data and when a charging voltage, which is applied to the charge connection section after the electronic device transmits the second certification data, is included in a prescribed range, and cannot be electrically conducted at least when the received first certification data is not the prescribed data, and
wherein the secondary battery can be charged through any one of the second charge control section and the switch section.

14. The electronic device of claim 13,
wherein at least command data or message data can be transmitted and received through the communication connection section, and
wherein the charging power is supplied to the secondary battery through any one of the second charge control section and the switch section in response to the transmitted command data or message data.

15. The electronic device of claim 13,
wherein the charging power which is output from the first charge connection section is greater than the charging power which is output from the second charge connection section.
